(19) United States
(12) Patent Application Publication
(10) Pub. No.: US 2024/0344760 A1
(43) Pub. Date: Oct. 17, 2024

(54) AUTOMATIC WATER FILLER

(71) Applicant: Hisense USA Corporation, Suwanee, GA (US)

(72) Inventors: Heng Tong Pit, Suwanee, GA (US); Jeesuk Lee, Johns Creek, GA (US); Steven J. Kuehl, Sylva, NC (US); JinXiong Pi, Suwanee, GA (US); XueQing Liu, Suwanee, GA (US)

(73) Assignee: Hisense USA Corporation, Suwanee, GA (US)

(21) Appl. No.: 18/636,040

(22) Filed: Apr. 15, 2024

Related U.S. Application Data
(60) Provisional application No. 63/459,456, filed on Apr. 14, 2023.

(51) Int. Cl. F25D 23/12

(52) U.S. Cl. CPC F25D 23/126; F25D 2323/122; F25D 2700/06

(57) ABSTRACT

A refrigerator includes an automatic filing water storage system. The refrigerator includes a cabinet having a fresh-food compartment and a door pivotally mounted to the cabinet. The system includes a dispenser positioned in the fresh-food compartment and a docking base positioned in one of the fresh-food compartment and the door. A container is configured to be supported by the docking base. In a docked position and when the door is in a closed position, the dispenser is configured to selectively dispense liquid into the container based upon a sensed fill level condition. When the door is in an open position, the dispenser is configured to dispense liquid based upon engagement of an actuator by a user.

### CROSS-REFERENCE TO RELATED APPLICATION

This application claims benefit and priority under 35 U.S.C. § 119 (e) to U.S. Provisional Patent Application No. 63/459,456, filed Apr. 14, 2023, the content of which is considered part of this application and is hereby incorporated by reference in its entirety.

### TECHNICAL FIELD

The present disclosure relates generally to refrigerator water storage system, and more specifically to an automatically refilling refrigerator water storage system, assemblies, subassemblies, and components thereof.

### BACKGROUND

Refrigerators may incorporate water dispensing systems and water storage systems to dispense and store chilled water. Conventional systems require a user to manually present a water storage receptacle, such as a pitcher or water tank, to a water dispenser for dispensing water for storage in the water receptacle. Therefore, there exists an opportunity to provide an improved water storage system that automatically refills a measured quantity of chilled water.

### SUMMARY

One aspect of the disclosure provides a refrigerator having an automatic water filling and storage system. The refrigerator may include a cabinet having a fresh-food compartment and a door pivotally mounted to the cabinet to access the fresh-food compartment. A dispenser that selectively dispenses water may be located in the cabinet. A docking base for receiving a pitcher may be located in the door. When the pitcher is in a docked position and the access door is closed, the dispenser is configured to selectively dispense water into the pitcher to fill the pitcher. When the door is open, the dispenser may accessed by a user to selectively dispense water into a secondary container or vessel.

In some examples, the dispenser is integrated into an interior surface of the cabinet of the fresh-food compartment. The dispenser may, for example, be integrated into an interior surface of the top wall of the cabinet. In other examples, the dispenser may be integrated into an interior surface of the side wall of the cabinet. The water dispenser may include an actuator that may be activated by a user to selectively dispense water, such as to dispense water into a container or other vessel held or otherwise supported by the user.

In some examples, the docking base may be integrated into a storage bin of the access door or an interior shelf of the cabinet. The docking base may be configured to position and orient a pitcher to engage the dispenser. In some examples, the refrigerator may include a variety of sensors, magnets, or contacts configured to sense the position and orientation of the pitcher. The water dispenser may be configured to selectively dispense water when the pitcher is provided in the docked position such that the pitcher is appropriately positioned and oriented to engage the dispenser. In some examples, the water dispenser may be configured to selectively dispense water when a user activates an actuator. The water dispenser may be configured to dispense water by user activation when a pitcher is not positioned in the docking station. In other examples, the water dispenser may be configured to dispense water by user activation when a pitcher is positioned in the docking station.

In some examples, the pitcher may include or be configured to interact with a variety of sensors, magnets, or contacts configured to sense the fill level condition of the pitcher. When the fill level condition meets or exceeds a high-level threshold, the water dispenser will not engage. When the fill level condition is not met, the water dispenser may be engaged when the pitcher is appropriately positioned. When the fill level condition is not met, the dispenser may selectively dispense water into the pitcher when the access door is closed and the pitcher is aligned to engage a dispenser nozzle. When the fill level condition is not met, the dispense may not dispense water into the pitcher when the access door is open and the pitcher is not aligned with the dispenser nozzle.

Another aspect of this disclosure is a water storage system for a refrigerator. The system may include a water dispenser for selectively dispensing water, a water pitcher, and a docking base for supporting the water pitcher. In a first position when a refrigerator door is closed and the water pitcher is supported by the docking base, the water dispenser may be configured to dispense water into the water pitcher. In examples, the water dispenser may selectively dispense water in the pitcher based upon a liquid level in the pitcher. When a liquid level meets a high-level threshold, the water dispenser may stop dispensing water. In a second position when a refrigerator door is open and the water pitcher is supported by the docking base, the water dispenser may be configured to dispense water upon activation of an actuator by a user.

Another aspect of this disclosure is a system for filling and storing water in a refrigerator. The system may include a cabinet and a door pivotally mounted to the cabinet. The system may include a dispenser positioned in the cabinet and configured to selectively dispense liquid into a container. The system may include a dock positioned in the door and configured to hold the container. When the door is in an open positioned, the container may be positioned away from the dispenser and the dispenser is configured to dispense liquid upon engagement of an actuator. When the door is in a closed position, the container may be positioned adjacent to the dispenser and the dispenser is configured to dispense liquid into the container based upon a sensed fill level condition of the container

The details of one or more implementation of the disclosure are set forth in the accompanying drawings and the description below. Other aspects, advantages, purposes, and feature will be apparent upon review of the following specification in conjunction with the drawings.

### BRIEF DESCRIPTION OF THE DRAWINGS

FIG. 1 is a schematic front view of a refrigerator with a closed access door, the refrigerator including an automatic water filler;

FIG. 2 is a schematic perspective view of a refrigerator with an open access door, the refrigerator including an automatic water filler;

FIG. 2A is a schematic front view of the automatic water filler of FIG. 2 with the refrigerator access door in a closed position;

FIG. 3 is a schematic perspective view of a refrigerator with an open access door, the refrigerator including an automatic water filler;

FIG. 3A is a schematic front view of the automatic water filler of FIG. 3 with the refrigerator access door in a closed position;

FIG. 4 is a schematic perspective view of a refrigerator with an open access door, the refrigerator including an automatic water filler;

FIG. 4A is a schematic front view of the automatic water filler of FIG. 4 with the refrigerator access door in a closed position;

FIG. 5 is a schematic perspective view of a refrigerator with an open access door, the refrigerator including an automatic water filler;

FIG. 5A is a schematic front view of the automatic water filler of FIG. 5 with the refrigerator access door in a closed position;

FIG. 6 is a schematic perspective view of a refrigerator with an open access door, the refrigerator including an automatic water filler;

FIG. 7 is a schematic side view of a water storage system;

FIG. 8 is a schematic view of an exemplary water dispenser system for a refrigerator;

FIG. 9 is a schematic side view of a water pitcher and docking base in a first position;

FIG. 10 is a schematic side view of a water pitcher and docking base in a second position;

FIG. 11 is a schematic side view of a water pitcher and docking base in a third position;

FIG. 12 is a schematic side view of a water pitcher in a fourth position; and

FIG. 13 is a flow chart showing the operation of the automatically filling water storage system.

Like reference numerals indicate like parts throughout the drawings.

### DETAILED DESCRIPTION

A refrigerator is a household appliance with a refrigeration compartment and in some instances may also have a freezer compartment. The refrigerator may attach to a water source to incorporate a water dispenser at an interior surface of a door enclosing one of the compartments and/or on a wall surface of the refrigeration compartment. Also, a liquid storage compartment, such as a pitcher, may be provided in an interior portion of the refrigeration compartment and/or on a door portion. The refrigerator disclosure herein provides an automatically refilling liquid storage receptacle that engages the water dispenser provided in the interior portion of the refrigeration compartment.

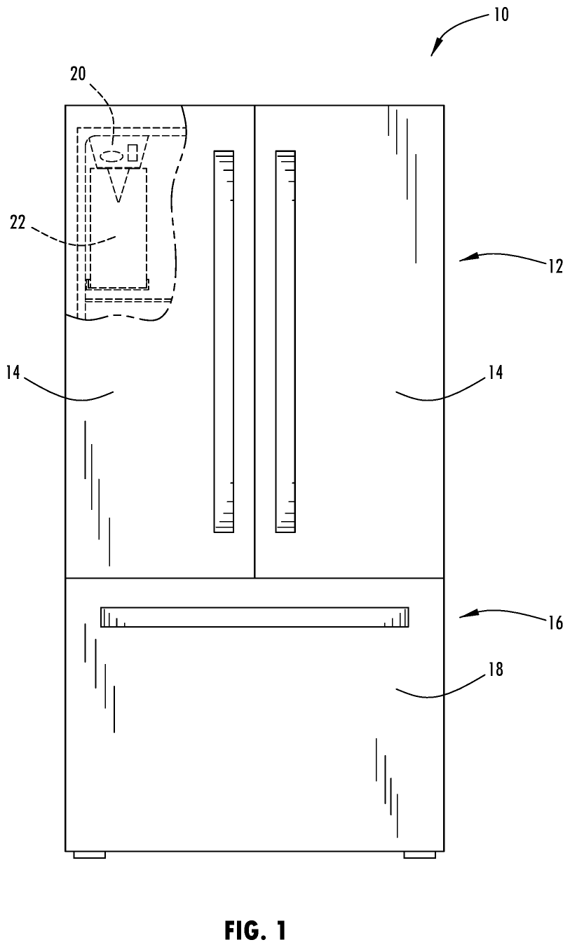

Referring to FIG. 1, an example of a refrigerator 10 is provided, showing a refrigeration cabinet having an interior compartment, which may be referred to as a fresh food storage section or compartment 12 of the refrigerator 10. The fresh food storage section 12 is enclosed by two front access doors 14 in a French-door configuration which are pivotally mounted to the cabinet. In other examples, the fresh food storage section may have a single door pivotally mounted to the cabinet. The door 14 is movable between a closed position at least partially enclosing the fresh-food compartment 12 and an open position for providing a user access to the fresh-food compartment 12. The refrigerator 10 also includes a freezer compartment, or a frozen food storage section 16 positioned below the fresh food storage section 12. The frozen food storage section 16 is enclosed by a single access door 18 in a sliding pull-out configuration. In other examples, the frozen food section may be positioned adjacent to the fresh food storage section such that the fresh food storage section and the frozen food storage section are in a side-by-side door configuration.

The refrigerator may include an integrated water dispenser 20 coupled to the cabinet 12 within the interior compartment. The water dispenser 20 is integrated into a wall or door that at least partially encloses the fresh food storage section 12. For example, the water dispenser 20 may be located in an interior surface of the fresh food storage section 12, such as at a top wall or a side wall of the fresh-food compartment 12. In other examples, the water dispenser may be integrated in an external surface of an access door to the fresh food storage system. An automatically filing water storage receptacle, for example a pitcher, 22 is provided to be stored in the fresh food storage section 12. The pitcher 22 may be configured to interface with the water dispenser 20 when the access door 14 is closed.

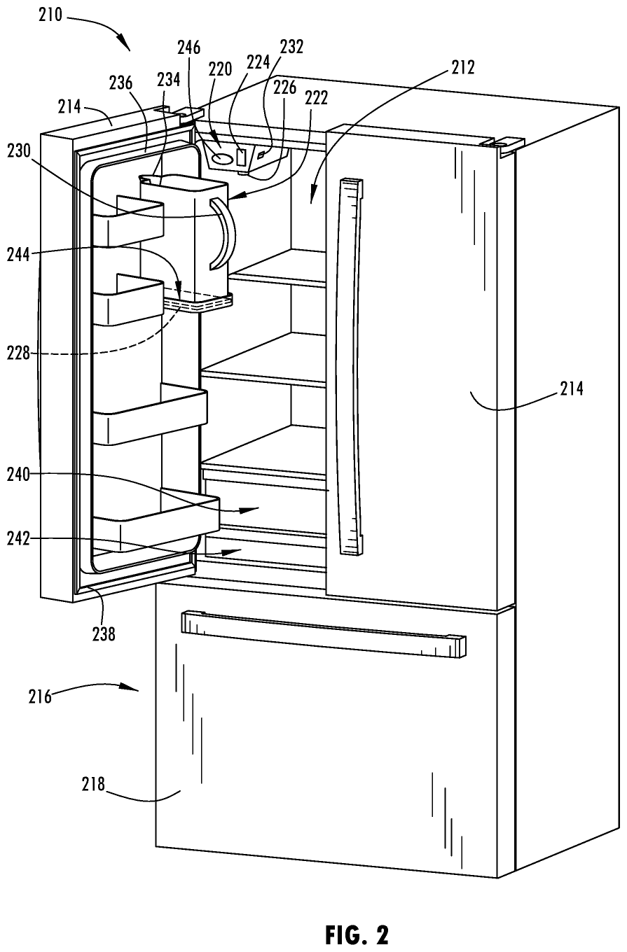

Referring now to FIGS. 2 and 2A, a schematic partial view of a refrigerator 210 is provided. More specifically, a view of a fresh food storage section 212 of the refrigerator 210 with an access door 214 in an open position is shown in FIG. 2. The refrigerator 210 includes a water dispenser 220 coupled to an interior surface of the cabinet 212. More, specifically, the dispenser 220 is coupled to the interior surface of a top wall of the refrigerator 210. The water dispenser 220 may include an actuator 224, such as a button or a switch, in close proximity to a dispenser nozzle 226. In examples, when the door 214 is in the open position, a user may place a secondary container held in the user's hand beneath the dispenser nozzle 226 to engage the dispenser 220 by pressing the actuator 224, thereby dispensing chilled water into the secondary container. The dispenser 220 may also be engaged by a removable water container, such as a pitcher 222, that can be docked in the refrigerator 210. In this example, the dispenser 220 may be accessed directly by the user with a glass or other secondary container held in a user's hand, irrespective of whether the pitcher 222 is removed from the docked position in the door 214. When the door 214 is in the closed position and the pitcher 222 is docked in the refrigerator 210, the actuator 224 may be configured to be actuated by the pitcher 222 and the dispenser 220 is configured to selectively dispense water into the pitcher 222, such as based upon a sensed level of liquid in the pitcher 222. In other examples, the dispenser may not include a user activated actuator and may solely be used by engaging a pitcher with the dispenser.

As further shown in FIGS. 2 and 2A, the pitcher 222 may be stored in a docking station 228 that is coupled to an interior side of the door 214. For example, the docking station 228 may be configured as a storage bin 244 on an interior surface of the access door 214. The pitcher 222 is configured to automatically interface with the water dispenser 220 when the access door 214 is in the closed position as illustrated in FIG. 2A to automatically fill water into the pitcher 222 when the pitcher 222 is empty or has a liquid below a low-level threshold, and to stop filling or disengage the water dispenser 220 when the pitcher 222 is full or has a liquid that meets or exceeds a high-level threshold. The docking base 228 is configured to engage the pitcher 222 such that it ensures the proper placement and orientation of the pitcher 222 relative to the water dispenser 220 when the access door 214 is in a closed position. The pitcher 222 may be provided with a handle 230 that may extend from the pitcher 222 to aid in handling the pitcher 222. The pitcher 222 may be positioned in the docking station 228 to allow the handle 230 to extend outwards for ease of use by a user. The storage bin 244 may be sized to store only the pitcher 222. In other examples, the storage bin 244 may be sized to store two gallon-sized containers and be removably mounted to an interior surface of the access door. The pitcher 222 may occupy less than about one half of the storage bin capacity. For example, the pitcher may be sized to contain about one gallon of water. In other alternatives, the pitcher may be larger or smaller and be sized to contain about one-half gallon, one-and-a-half liters, two liters, one-and-a-half gallons, or other suitable sizes. The pitcher may be sized to be integrated into existing refrigerator designs, maintaining clearance from a door dyke 36, door gaskets and seals 38, and additional storage bins such as crisper bins 40 or deli/pantry bins 42.

In examples, the pitcher 222 may include a variety of magnets, contacts, or sensors 246 configured to engage the water dispenser 220 and engage a control switch 232 to determine when to selectively dispense water. For example, the pitcher 222 and water dispenser 220 may include presence sensors or other accessories which are configured to determine when the pitcher is docked and aligned with the dispenser nozzle 226. In other examples, the pitcher 222 and water dispenser 220 may include a fluid level sensor or other accessory for sensing the liquid level of the pitcher. The magnets, contacts, and/or sensors 246 may be electrically coupled to the control switch 232 for determining when the water dispenser 220 should be engaged to automatically fill the pitcher 222 with water. The pitcher 222 may include a spout 234 which may be used to aid in pouring liquid from the pitcher 222 when the pitcher 222 is removed from the docking station 228 and refrigerator 210. In some examples, the spout 234 may be configured as a contact that extends outwardly from the pitcher 222 so that, when properly placed in the docking station 228, the spout 234 may contact or press an actuator 224 to actuate the water dispenser 220.

As illustrated in FIGS. 2 and 2A, when the access door 214 is in an open position (FIG. 2), the pitcher 222 is positioned away from the water dispenser 220, such that the water dispenser 220 may be engaged by a user with a separate fluid container such as a glass. When the access door 214 is in a closed position (FIG. 2A), the pitcher 222 is positioned below the water dispenser 220, such that an opening in the pitcher 222 is aligned with the dispenser nozzle 226 and water may be dispensed from the dispenser nozzle 226 directly into the body of the pitcher 222.

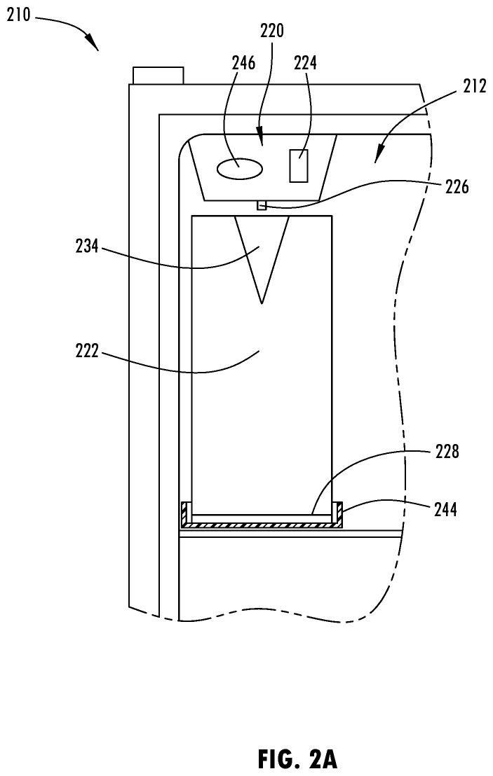

Referring now to FIGS. 3 and 3A, a schematic partial view of a refrigerator 310 is provided. More specifically, a view of a fresh food storage section 312 of the refrigerator 310 with an access door 314 in an open position is shown in FIG. 3. The refrigerator 310 is provided with a water dispenser 320 integrated into the interior surface of the top wall of the fresh food storage section 312. A pitcher 322 is provided on an internal shelf 345 on the fresh food storage section 312. The shelf 345 may include a docking station 328 for receiving the pitcher 322 on the shelf 345. The shelf 345 is provided at a distance below the water dispenser 320 approximately the height of the pitcher 322, such that the pitcher 322 may be stored on the shelf 345 directly below the water dispenser 320 and a dispenser nozzle 326 may engage the pitcher 322 to selectively dispense water into a body of the pitcher 322.

In examples, an actuator 324 may be provided that a user may press to engage the dispenser 320 to dispense water. For example, when the pitcher 322 is not provided on the docking station 328 and is not positioned to engage the water dispenser 320, a user may place a different fluid container under the dispenser nozzle 326 to receive water from the dispenser 320. In other examples, the water dispenser 320 may not include an actuator 324 and may only be engaged with by the pitcher 322 when positioned in the docking station 328.

In examples, the dispenser 320 may include a variety of magnets, contacts, or sensors 346 for determining when to selectively engage the water dispenser 320 to dispense liquid. For example, a proximity sensor or contact may be provided in at least one of the docking station 328, the pitcher 322, or the dispenser 320 which determines when the pitcher 322 is provided in the docking station 328 in the correct position and orientation to appropriately engage the dispenser 320. In other examples, a fluid level sensor may be provided in at least one of the docking station 328, the pitcher 322, or the dispenser 320 which determines the level of liquid in the pitcher 322. When the proximity sensor determines the pitcher 322 is not positioned in the docking station 328, the dispenser 320 is not engaged unless a user engages the actuator 324. When a proximity sensor determines the pitcher 322 is positioned in the docking station 328 and the fluid level sensor determines the pitcher 322 is empty or has a liquid below a low-level threshold, the dispenser 320 is engaged to dispense water into the pitcher 322. When the proximity sensor determines the pitcher 322 is positioned in the docking station 328 and the fluid level sensor determines the pitcher 322 is full or has a liquid that meets or exceeds a high-level threshold, the dispenser 320 is disengaged to stop filling the pitcher 322.

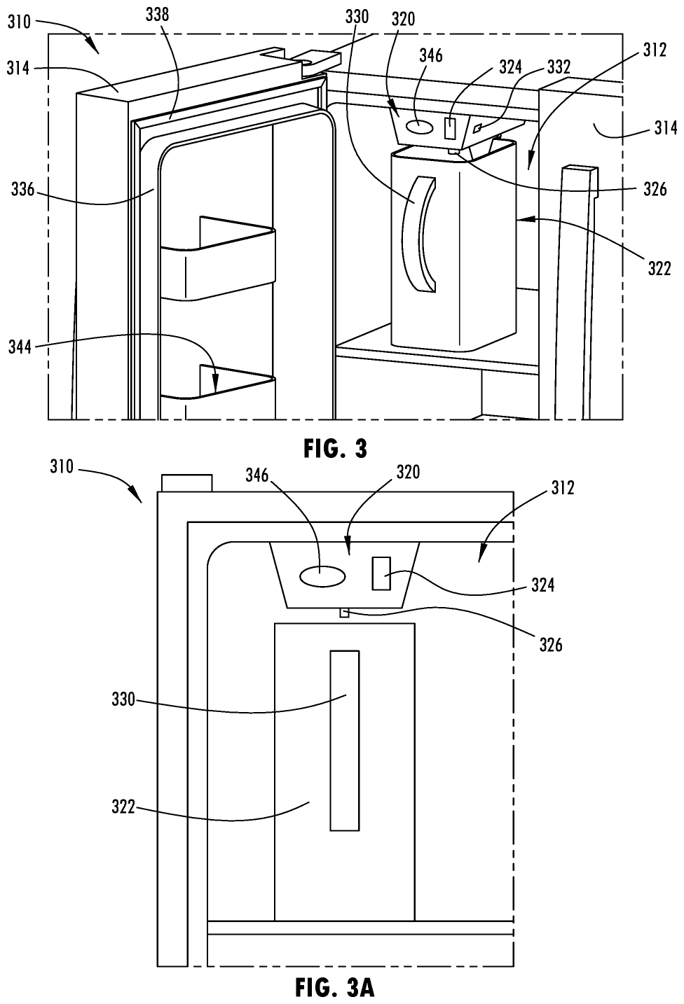

Referring to FIGS. 4 and 4A, a schematic partial view of a refrigerator 410 is provided. More specifically, a view of a fresh food storage section 412 of the refrigerator 410 with an access door 414 in an open position is shown in FIG. 4. The refrigerator 410 is provided with a water dispenser 420 integrated into the interior surface of the side wall of the fresh food storage section 412. The dispenser may include an actuator 424 that is controlled by a user. In one example, the user may open the access door 414 to the fresh food storage section 412 to place a glass or other fluid container beneath a dispenser nozzle 426 and actuate the dispenser 420 to dispense chilled water into the fluid container. In other examples, a pitcher 422 may be provided that can be stored on a shelf 445 within the fresh food storage section 412. The pitcher 422 may be configured to automatically interface with the water dispenser 420 when the access door 414 is in the closed position to automatically fill water into the pitcher 422 when the pitcher 422 has a low water level and to automatically fill water into the pitcher 422 when the pitcher 422 has a high water level. For example, a variety of weights, sensors, or contacts may be provided in the dispenser 420, pitcher 422, or a docking station 428 to determine when the pitcher 422 is positioned to engage the water dispenser 420 and when the liquid in the pitcher 422 is below a high-level threshold and thus can be filled with more water.

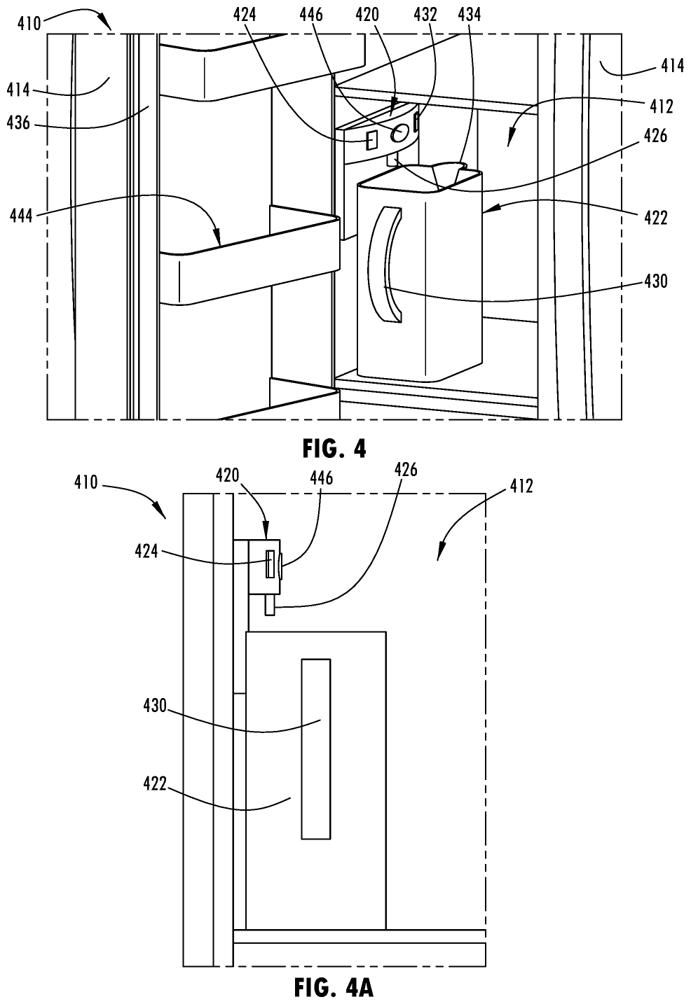

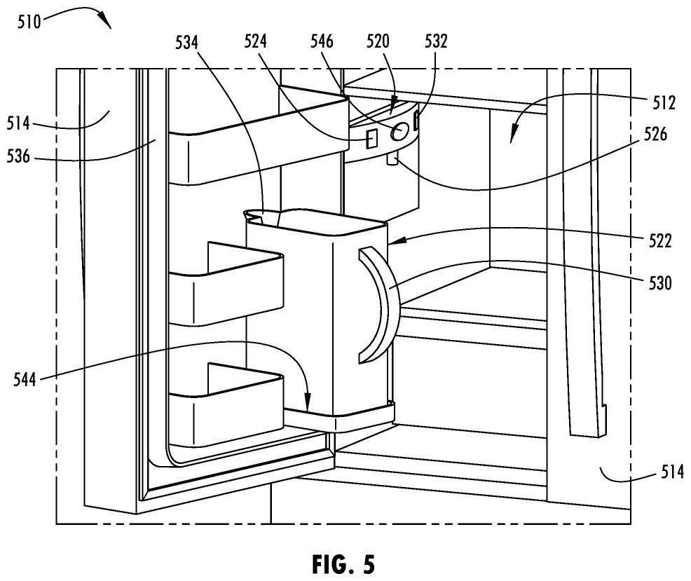

Referring to FIGS. 5 and 5A, a schematic partial view of a refrigerator 510 is provided. More specifically, a view of a fresh food storage section 512 of the refrigerator with an access door 514 in an open position is shown in FIG. 5. The refrigerator 510 includes a water dispenser 520. The water dispenser 520 may be integrated into the interior surface of the side wall of the refrigerator 510 and may include an actuator 524, such as a button or switch, in close proximity to a dispenser nozzle 526. In one example use case, the user opens the access door 514 to the fresh food storage section 512, places a water glass or other fluid container beneath the dispenser nozzle 526 and actuates the dispenser 520 by pressing the button 524, thereby dispensing chilled water into the fluid container.

The refrigerator 510 includes an automatically filling water storage receptacle, such as a pitcher 522, that can be stored in a storage bin 544 of the access door 514. The pitcher 522 is configured to automatically interface with the water dispenser 520 when the access door 514 is in the closed position to automatically fill water into the pitcher 522 when the pitcher 522 has a low water level and to automatically disengage the water dispenser 520 when the pitcher 522 has a high water level. The storage bin 544 may incorporate or may be provided with a docking base 528 for engaging the pitcher 522 to ensure the proper placement and orientation of the pitcher 522 relative to the water dispenser 520.

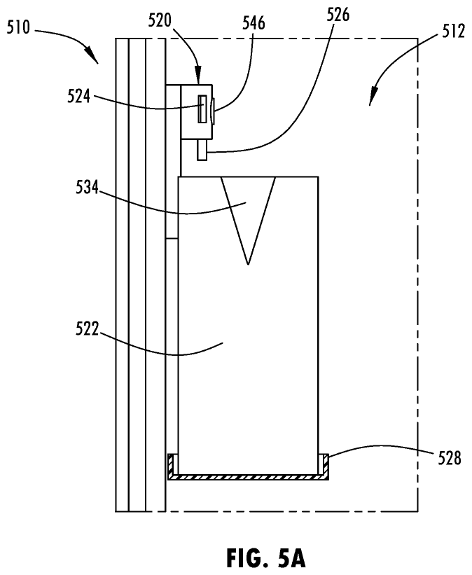

Referring now to FIG. 7, an exemplary piping diagram is provided for the refrigerator 10 illustrated in FIG. 1. The refrigerator 10 may be connected to a water source 52, such as a residence's domestic fresh water service. The refrigerator 10 may incorporate a filtering device 54, such as a replaceable, disposable, or cartridge filter device 54 for removing impurities or particulate debris from the water supply, preventing clogging of downstream components, and avoiding unpleasant or undesirable flavors or odors in the water. The filter device 54 may include an activated carbon filter, such as from charcoal, nutshells or wood, or other suitable media. After filtering the water may be directed through a fill valve 56. The fill valve 56 may supply one or more fluid circuits, for example, to supply the water dispenser 20 in the fresh food storage section 12 and to an automatic ice maker 58 provided in a freezer section 16. Between the fill valve 56 and the water dispenser 20, the refrigerator 10 may include a water tank 62 permanently provided in the fresh food storage section 12 in order to increase the ready supply of chilled water for dispensing through the dispenser 20. A water valve 64 may be provided proximate to the water tank 62 to control the fill level of the water tank 62 and assist in communicating the water from the water tank 62 to the water dispenser 20. A control switch 32 may be provided proximate the water dispenser 20 that the user can actuate and control the water flow through the water dispenser 20. In examples, the fluid circuits which provide water from the water source 52 to the water dispenser 20 are disposed in the cabinet of the refrigerator 10. The fluid circuits do not pass into the access door 14 of the fresh food compartment 12. This arrangement is illustrative of an exemplary implementation and is not intended to be limited. Alternative arrangements are contemplated to be within the scope of the present disclosure, for example, that omit the filter 54, the automatic ice maker 58, or otherwise. Alternative arrangements may also include the water dispenser being positioned in a different location of the refrigerator, for example, in the side surface of the fresh food storage section.

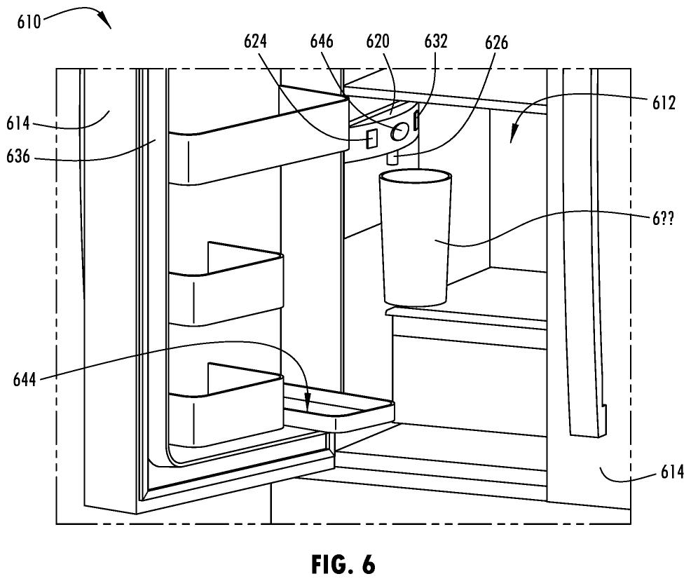

Referring now to FIGS. 8-12, an exemplary water pitcher 22 and docking base 28 are illustrated. The water pitcher 22 and docking base 28 are designed so that the weight of the water changes the center of gravity of the water pitcher 22 and induces a change in position or orientation on the docking base 28 so that an empty or partially empty water pitcher 22, that is one with a low fill level condition, engages the water dispenser 20 to dispenses water into the pitcher 22, and a full water pitcher 22, that is one with a high fill level condition, disengages from the water dispenser 20. While shown in isolation in FIGS. 8-11, the docking base 28 may be integrated into the bottom of the storage bin 44 or an internal shelf for receiving and supporting the water pitcher 22 in the refrigerator 10.

The water pitcher 22 includes a pitcher body 68. A handle 30 may extend from the pitcher body 68 to aid in handling the water pitcher 22. A pivoting lid 72 may enclose the pitcher body and incorporate a spout 34. In some examples, the spout 35 may be configured to engaging the water dispenser 20. For example, the spout 34 may include a fluid communication pathway to the interior of the pitcher 22 to receive the water dispensed by the water dispenser 20 and direct it into the pitcher 22. In other examples, the lid 72 may include a separate fluid communication pathway for engaging the dispensing nozzle 26 of the dispenser 20. In further examples, the pitcher 22 may not include a lid and the water may be dispensed directly into an opening of the pitcher body 68. The lid 72 may interface with the pitcher body 68 across a range of angles, such as with a gimbal, so that the lid 72 can remain substantially horizontal, or otherwise in the proper orientation to engage the water dispenser 20 when the water pitcher 22 is empty or partially empty while also engaging the pitcher body 68 when the water pitcher 22 is full. The water pitcher 22 includes an interior divider wall 74 that effectively divides the water pitcher 22 into two sections. The divider wall 74 is substantially vertical, but angled in such a way as to define a first fill volume 76, and a second fill volume 78, together defining a plurality of fill volumes. The first fill volume 76 is located on the side of the divider wall 74 toward the spout 34. Water entering from the water dispenser 20 will accumulate within the first fill volume 76, increasing the weight concentrated on that side of the divider wall 74 and maintaining the water pitcher 22 angled toward the water dispenser 20 on the docking base 28. As water continues to fill the pitcher body 68, the water level will rise to the top of the divider wall 74 and begin filling the second fill volume 78. Ultimately, the weight of the water in the second fill volume 78 will move the center of gravity of the full water pitcher 22 away from the water dispenser 20, causing the water pitcher to pivot on the docking base to disengage from and deactivate the water dispenser 20.

A flapper valve 80 may be provided at the base of the divider wall 74 that allows one-way fluid equilibrium from the second fill volume 78 to the first fill volume 76 due to a hydrostatic pressure differential arising from a higher water column in the second fill volume 78, such as may occur when the water pitcher is being emptied through the spout 34, for example, into a drinking glass. The flapper valve 80 may extend along all or a portion of the divider wall 74 across the width of the water pitcher 22. The flapper valve 80 may be formed of a resilient material, such as a rubber or other elastomeric material.

The docking base 28 includes an indexing feature 82 that positively locates the water pitcher 22 in the proper location to engage the water dispenser 20. In one exemplary implementation, the indexing feature 82 includes a rounded ridge formed in the docking base 28 and a corresponding rounded channel formed in the pitcher body 68. The indexing feature 82 may provide a pivot point about which the water pitcher 22 rotates as the pitcher 22 moves from the first position engaging the water dispenser 20 to the second position disengaged from the water dispenser 20. On one side of the indexing feature 82, the docking base 28 may include a first support portion as sloped surface 84 that allows the water pitcher 22 to lean toward the water dispenser 20. On the other side of the indexing feature 82, the docking base may include a second support portion flat surface 86 that allows the water pitcher 22 to rest vertically, and spaced from the water dispenser 20. The storage bin 44 or the docking base 28 may include a side wall or partition to maintain a separation between the water pitcher's 22 operational space and any other foodstuffs that a user may seek to store in the storage bin 44.

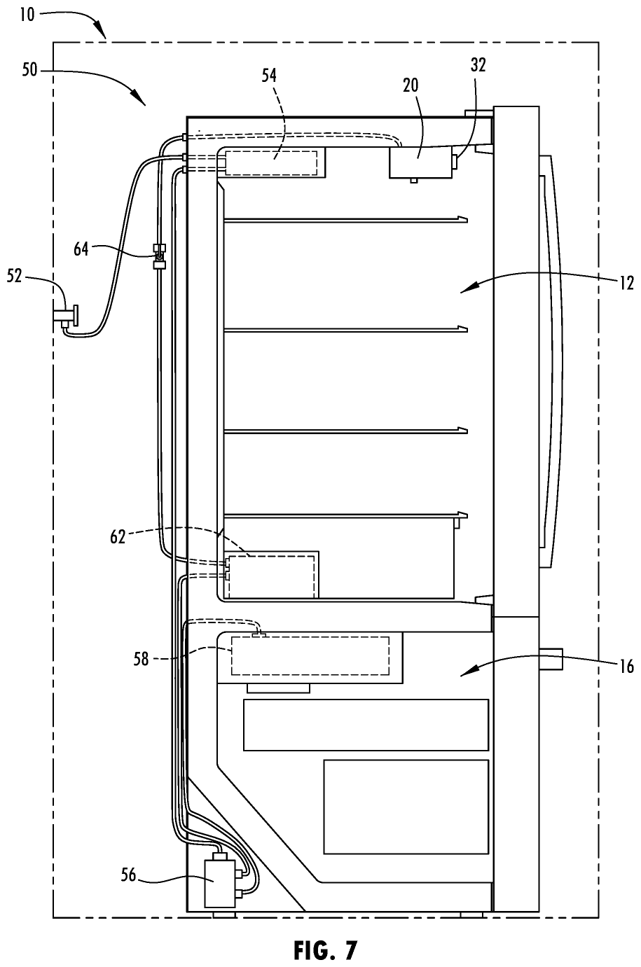

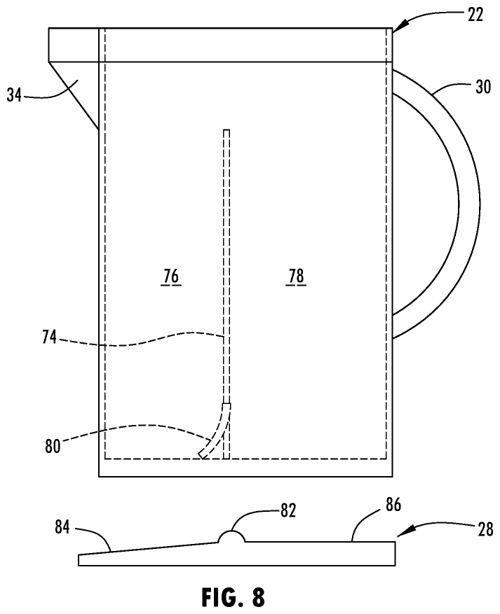

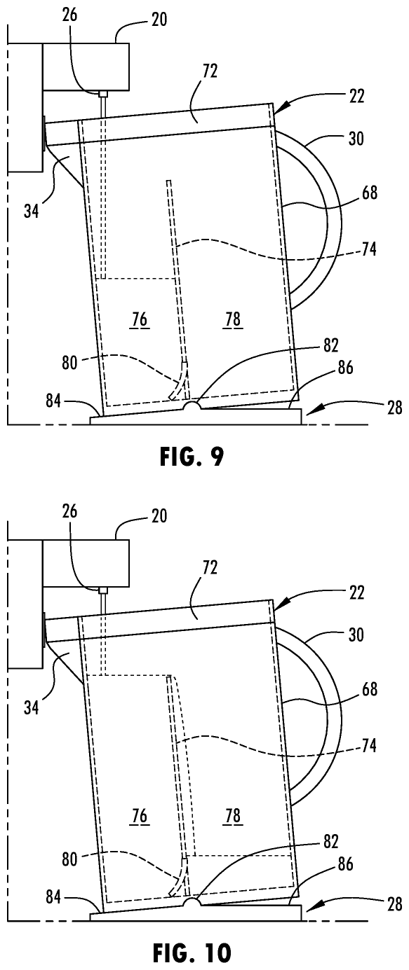

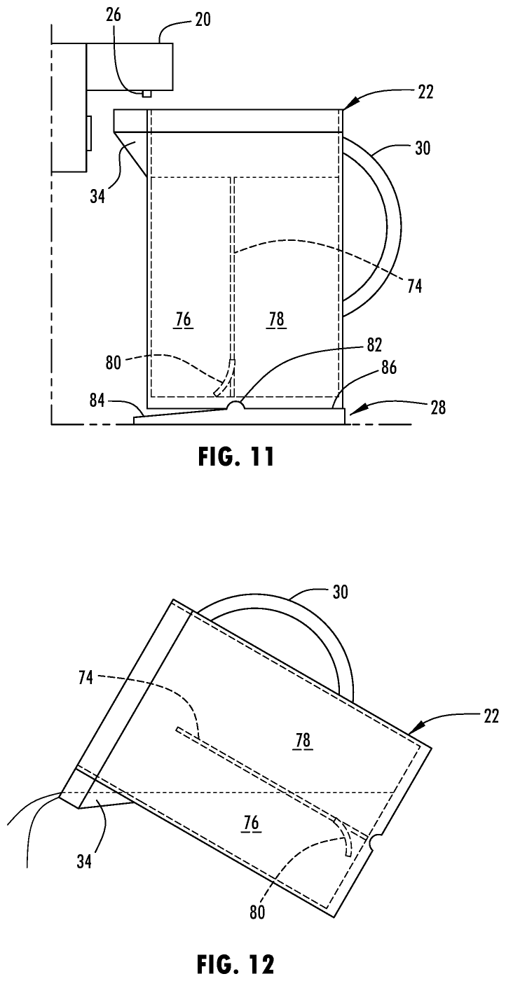

Referring now to FIGS. 9-12, the operational states of the water pitcher 22 and docking base 28 are illustrated. In a first state, illustrated in FIG. 9, the water pitcher 22 may be placed on the docking base 28. The indexing feature 82 causes the water pitcher 22, under the force of gravity, to assume the proper position and orientation on the docking base 28 for engaging the water dispenser 20. In another example implementation, magnets may be provided in the indexing feature 82 and the pitcher body 68, or in the water dispenser 20 and the spout 34, to aid the water pitcher 22 in achieving the proper position and orientation. In a second state, illustrated in FIG. 10, water has been dispensed from the dispenser 20 into the water pitcher 22 to fill the first fill volume 76 with liquid. Water is now able to flow over the divider wall 74 into the second fill volume 78. The greater weight of water in the first fill volume 76 ensures that the flapper valve 80 stays closed and the center of gravity of the pitcher 22 generally remains towards the water dispenser 20 to maintain the engagement and dispense additional water into the water pitcher 22. In a third state, illustrated in FIG. 11, water has filled the water pitcher 22 up to a substantially equal level in the first fill volume 76 and the second fill volume 78, which has moved the center of gravity of the water pitcher 22 toward the second fill volume side 78 and caused the water pitcher 22 to rotate about the indexing feature 82 away from the water dispenser 20 to disengage the dispenser 20 and stop the further dispensing of water in to the pitcher 22. In a fourth state, illustrated in FIG. 12, the pitcher 22 has been removed from the refrigerator 10 and may be tiled to allow a user to pour water from the spout 34 of the lid 72. The flapper 80 opens when tilted to allow water to pass from the second fill volume 78 to the first fill volume 76 as water is poured out of the pitcher 22.

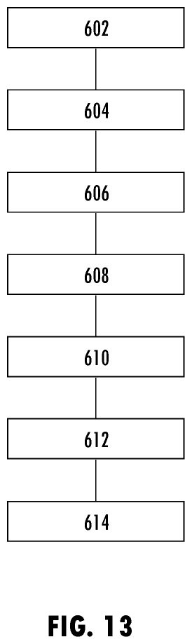

Referring now to FIG. 13, a method of automatically filling the water storage system is provided. In 602, a user opens an access door of a refrigerator and places a pitcher in a docking base which may be positioned in a storage bin or in an internal shelf of the fresh-food compartment. At 604, a user closes the access door. At 606, when the access door is closed and the pitcher is in a docked position, a sensor or other device may determine and sense that the pitcher is appropriately aligned to engage with a water dispenser. At 608, when the pitcher is appropriately aligned, a sensor or other device may determine that a fill level condition is below a threshold such that the pitcher is empty or that a liquid in the pitcher is below a high threshold. At 610, the water dispenser may dispense water into the pitcher to automatically fill the pitcher with water. At 612, the senor determines that the fill level condition is met such that the pitcher is full or that the liquid in the pitcher has met or exceeds the high threshold. At 614, when the fill level condition is met, the water dispenser disengages and stops filling the pitcher with water.

Additional variations and features will be readily appreciated by those of skilled in the art and can be practiced with the above described alternative implementations without departing from the scope of the disclosure. In one example, as an alternative to using magnetic attraction to aid in the aligning of the water pitcher 22 to the water dispenser 20, spring latching mechanisms may be employed such that the water pitcher 22 latches into a filling position upon the access door 14 being closed and where the spring force may be overcome by the changing center of gravity to disengage when the water pitcher 22 is filled. In other alternatives, the indexing feature 82 may not be a groove-and-channel cooperating between docking base 28 and the pitcher body 68 but instead may be an eccentric or cammed surface that induces a rotation of the water pitcher 22 to move the spout 34 away from the water dispenser 20 in a lateral sideways motion rather than a rotation away. In such an implementation, the interior divider wall 74 may take an alternate or more complex form, including dividing the pitcher body 68 into addition fill volumes beyond the first and second fill volumes 76, 78.

The refrigerator 10 may also be provided with error or failure detection means and deterrence. In one example, a time limit may be imposed on the operation of the water dispenser 20 to prevent a single, continuing dispensing from occurring while the access door 14 is shut greater than the maximum storage capacity of the water pitcher 22. Other water detectors or sensors may be provided near and below the water dispenser 20 to prevent the continued operation of the water dispenser 20 in the presence of water being detected within the fresh food storage section 12. Accordingly, visual or audible alarms may be provided to alert a user upon an error or fault detection event. Switch sensitivity may be increased and delay in actuation may be implemented so as to not dispense water unless the button 24 is engaged continuously for a minimum amount of time i.e., 3 seconds. In further alternatives, multiple interfaces or switches may be provided to allow the water pitcher 22 to interface and actuate the water dispenser 20 and to allow a human user to interface and actuate the water dispenser 20 separately from water pitcher 22.

In further alternatives, the pitcher 22 may be provided with alternative shapes and configurations. For example, the pitcher 22 may include a water dispensing system as described in the disclosure of U.S. Provisional Patent Application 63/459,460 and its further continuations, such that a user may dispense water from the pitcher without removing the pitcher from the docking base and storage shelf.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A refrigerator having an automatic water filling and storage system, the refrigerator comprising:
a cabinet having a fresh-food compartment;
a door pivotally mounted to the cabinet and movable between a closed position at least partially enclosing the fresh-food compartment and an open position for providing a user access to the fresh-food compartment;
a water dispenser coupled to an interior surface the cabinet;
a docking base coupled to an interior side of the door; and
a container removably held in the docking base,
wherein, when the door is in the open position, the water dispenser is configured to dispense water into a secondary container held by the user, and
wherein, when the container is held in the docking base and the door is in the closed position, the water dispenser is configured to selectively dispense water into the container based upon a sensed level of water in the container.

2. The refrigerator of claim 1, wherein the water dispenser is located at a top wall of the fresh-food compartment.

3. The refrigerator of claim 1, wherein the water dispenser is located at a side wall of the fresh-food compartment.

4. The refrigerator of claim 1, wherein the container has an opening that is configured to align with a nozzle of the water dispenser when the door is in the closed position.

5. The refrigerator of claim 1, wherein the water dispenser comprises an actuator configured to be actuated by the user when the door is in the open position to dispense water from the water dispenser.

6. The refrigerator of claim 5, wherein the actuator is configured to be actuated by the container when the door is in the closed position to selectively dispense water from the water dispenser based upon the sensed level of water in the container.

7. The refrigerator of claim 1, further comprising a level sensor configured to sense a level of water in the container held in the docking base, wherein, when the door is in the closed position and the level of water sensed is below a low-level threshold, the water dispenser dispenses water into the container.

8. The refrigerator of claim 7, wherein, when the door is in the closed position and the level of water sensed is above a high-level threshold, the water dispenser does not dispense water into the container.

9. The refrigerator of claim 1, further comprising a presence sensor configured to sense the container in the docking base, wherein, when the container is removed from the docking base, the presence sensor senses the docking base is void of the container and the water dispenser does not dispense water when the door is closed.

10. A refrigerator having an automatic water filling and storage system, the refrigerator comprising:
a cabinet having an interior compartment;
a door pivotally mounted to the cabinet;
a water dispenser coupled to the cabinet within the interior compartment; and
a docking base coupled to the door for supporting a removable water container,
wherein, when the door is in a closed position, the removable water container is configured to engage the water dispenser and the water dispenser is configured to selectively dispense water into the removable water container, and
wherein, when the door is in an open position, the removable water container is configured to disengage the water dispenser and the water dispenser is configured to dispense water into a secondary container held by a user.

11. The refrigerator of claim 10, wherein the water dispenser is located at one of a top wall or a side wall of the cabinet.

12. The refrigerator of claim 10, wherein the removable water container has an opening that is configured to align with a nozzle of the water dispenser when the door is in the closed position and move out of alignment with the nozzle when the door is moved to the open position.

13. The refrigerator of claim 10, further comprising an actuator configured to be actuated by the user when the door is in the open position to cause the water dispenser to dispense water.

14. The refrigerator of claim 13, wherein the actuator is configured to be actuated by the removable water container when the door is in the closed position to selectively dispense water from the water dispenser into the removable water container.

15. The refrigerator of claim 10, further comprising a sensor configured to sense water in the removable water container when it is held in the docking base, wherein, when the door is closed, the water dispenser is configured to selectively dispense water into the removable water container based on the water sensed in the removable water container by the sensor.

16. The refrigerator of claim 15, wherein, when the door is in the closed position and the water sensed is above a high-level threshold, the water dispenser does not dispense water into the removable water container.

17. The refrigerator of claim 10, further comprising a presence sensor configured to sense the removable water container in the docking base, and wherein, when the removable water container is removed from the docking base, the presence sensor senses the docking base is void of the removable water container and the water dispenser is prevented from dispensing water when the door is in the closed position.

18. A system for automatically filling and storing water in a refrigerator, the system comprising:
a fresh-food compartment and a door pivotally mounted to the fresh-food compartment;
a dispenser located in the fresh-food compartment and configured to selectively dispense water into a container; and
a dock located in the door and configured to hold the container,
wherein, when the door is open, the container is positioned away from the dispenser and the dispenser is configured to dispense water upon actuation of an actuator, and
wherein, when the door is closed, the container is positioned adjacent to the dispenser and the dispenser is configured to dispense water into the container based upon a sensed level of water in the container.

19. The system of claim 18, wherein the actuator is configured to be actuated by the container when the door is closed to selectively dispense water from the dispenser based upon the sensed level of water in the container.

20. The system of claim 19, further comprising a level sensor configured to sense the level of water in the container held in the docking, wherein, when the door is closed and the sensed level of water in the container is below a low-level threshold, the dispenser dispenses water into the container.
